(19) United States
(12) Patent Application Publication
(10) Pub. No.: US 2019/0137065 A1
(43) Pub. Date: May 9, 2019

(54) LIGHTING DEVICE

(71) Applicant: KOITO MANUFACTURING CO., LTD., Tokyo (JP)

(72) Inventor: Hiroki Shibata, Shizuoka (JP)

(73) Assignee: KOITO MANUFACTURING CO., LTD., Tokyo (JP)

(21) Appl. No.: 16/096,998

(22) PCT Filed: Apr. 18, 2017
(86) PCT No.: PCT/JP2017/015596

§ 371 Date: Oct. 26, 2018

(30) Foreign Application Priority Data
Apr. 27, 2016 (JP) 2016-089552
Apr. 27, 2016 (JP) 2016-089553
Apr. 27, 2016 (JP) 2016-089554

(51) Int. Cl. F21S 41/19; F21S 45/47; F21S 41/33

(52) U.S. Cl. CPC F21S 41/192; F21Y 2107/50; F21S 41/33; F21S 45/47

(57) ABSTRACT

A lighting device mounted on a vehicle includes a first light source, a second light source, a heat dissipation member having a wall defining a hollow portion and configured to dissipate heat generated by operations of the first light source and the second light source, and a single reflector member mounted on the heat dissipation member. The first light source and the second light source are disposed at positions facing the hollow portion with the wall interposed therebetween, respectively. The first light source and the second light source are configured to emit light in directions intersecting with a front and rear direction, respectively. The reflector member has a first reflecting surface configured to reflect light emitted from the first light source in a predetermined direction, and a second reflecting surface configured to reflect light emitted from the second light source in a predetermined direction.

### CROSS-REFERENCE TO RELATED APPLICATIONS

The present application is a national stage application of PCT/JP2017/015596, and claims priority to Japanese Patent Application No. 2016-089552 filed on Apr. 27, 2016, Japanese Patent Application No. 2016-089553 filed on Apr. 27, 2016, and Japanese Patent Application No. 2016-089554 filed on Apr. 27, 2016, the contents of which are incorporated herein by reference in their entirety.

### BACKGROUND

### Technical Field

The disclosure relates to a lighting device mounted on a vehicle.

### Related Art

Patent Document 1 discloses a headlamp for a motorcycle, which is an example of this type of lighting device. The headlamp includes a plurality of light sources and a heat dissipation member. The heat dissipation member dissipates heat generated from the respective light sources. The plurality of light sources and the heat dissipation member are accommodated in a lamp chamber defined by a housing and a translucent cover. The translucent cover has a portion having a lens function. The light emitted from the respective light sources travels in a predetermined direction by passing through the portion having the lens function and illuminates the front of the headlamp with a predetermined light distribution pattern.

### CITATION LIST

### Patent Document

Patent Document 1: Japanese Patent Laid-Open Publication No. 2015-137031

### SUMMARY

There is a demand for suppressing an increase in the size of a lighting device including a plurality of light sources and a heat dissipation member.

A first aspect for meeting the above-described demand provides a lighting device mounted on a vehicle, the lighting device including:

a first light source;

a second light source;

a heat dissipation member having a wall defining a hollow portion and configured to dissipate heat generated by the operations of the first light source and the second light source; and

a single reflector member mounted on the heat dissipation member,

in which the first light source and the second light source are disposed at positions facing the hollow portion with the wall interposed therebetween, respectively,

in which the first light source and the second light source are configured to emit light in directions intersecting with a front and rear direction, respectively, and

in which the reflector member has

a first reflecting surface configured to reflect light emitted from the first light source in a predetermined direction, and

a second reflecting surface configured to reflect light emitted from the second light source in a predetermined direction.

According to the above configuration, the light emitted from the first light source is reflected by the first reflecting surface of the reflector member, and the light emitted from the second light source is reflected by the second reflecting surface of the reflector member. Since the space spreading in a direction intersecting with the front and rear direction of the lighting device having a relatively high degree of freedom of layout can be effectively utilized, it is easy to suppress an increase in the size in the front and rear direction of the lighting device, as compared to the configuration as disclosed in Patent Document in which the distribution of the light emitted forward from the light source is controlled by a lens part formed in the translucent cover.

Further, since the first light source and the second light source are disposed at positions facing the hollow portion of the heat dissipation member having a large surface area, the heat generated by the operations of the first light source and the second light source can be effectively dissipated. Therefore, the volume of the heat dissipation member necessary for obtaining desired heat dissipation performance can be reduced, and an increase in the size of the lighting device can be suppressed.

Furthermore, since the first reflecting surface and the second reflecting surface are parts of a single reflector member, the number of steps for mounting to the heat dissipation member can be minimized.

The lighting device can be configured as follows.

The lighting device includes

a first conducting wire electrically connected to the first light source; and

a second conducting wire electrically connected to the second light source.

in which the first conducting wire and the second conducting wire are disposed behind the reflector member.

According to this configuration, the reflector member mounted to the heat dissipation member can have a function of covering and concealing the first conducting wire and the second conducting wire. In this way, the number of parts is reduced, and an increase in the size of the lighting device including a plurality of light sources and the heat dissipation member can be suppressed.

Alternatively, the lighting device can be configured as follows.

The lighting device includes

a first conducting wire electrically connected to the first light source; and

a second conducting wire electrically connected to the second light source,

in which the first conducting wire and the second conducting wire extend in the hollow portion.

That is, the hollow portion formed for improving the heat dissipation property is utilized as a space for arranging the first conducting wire and the second conducting wire. In this way, the utilization efficiency of the space is improved, and an increase in the size of the lighting device including a plurality of light sources and the heat dissipation member can be suppressed.

In this case, the lighting device can be configured as follows.

The lighting device includes

a translucent cover through which light emitted from the first light source and the second light source is transmitted,

in which the translucent cover is mounted to the reflector member.

According to such a configuration, the reflector member can function as a housing defining the lamp chamber. A mechanism for adjusting the posture of the reflector member may be provided outside the reflector member, as necessary. Therefore, it is possible to further suppress an increase in the size of the lighting device including a plurality of light sources and the heat dissipation member.

The lighting device can be configured as follows.

The lighting device includes

a third light source disposed at a position facing the hollow portion with the wall interposed therebetween,

in which the third light source is configured to emit light in a direction intersecting with the front and rear direction.

According to such a configuration, three or more light sources can be arranged with high space utilization efficiency. In this way, an increase in the size of the lighting device including a plurality of light sources and the heat dissipation member can be suppressed.

The lighting device can be configured as follows.

The first light source is configured to emit light for illuminating a first area, and

the second light source is configured to emit light for illuminating a second area different from the first area.

According to such a configuration, a plurality of light sources for illuminating different areas can be arranged with high space utilization efficiency, and an increase in the size of the lighting device including a plurality of light sources and the heat dissipation member can be suppressed.

A second aspect for meeting the above-described demand provides a lighting device mounted on a vehicle, the lighting device including:

a first light source;

a first reflecting surface configured to reflect light emitted from the first light source in a predetermined direction;

a first conducting wire electrically connected to the first light source in front of the first reflecting surface;

a second light source;

a second reflecting surface configured to reflect light emitted from the second light source in a predetermined direction;

a second conducting wire electrically connected to the second light source in front of the second reflecting surface; and

an opaque cover covering the first conducting wire and the second conducting wire at least from the front.

When taking care not to hinder the progress of the reflected light, there is a relatively large space margin in front of the first reflecting surface and the second reflecting surface. By positively utilizing such a space and making electrical connection with the light source, it is possible to suppress an increase in the size of the lighting device including a plurality of light sources, particularly in the front and rear direction, as compared to the configuration in which electrical connection with the light source is made behind the reflecting surfaces.

On the other hand, the first conducting wire and the second conducting wire are covered by the opaque cover at least from the front. Therefore, even when an electrical connection portion with the light source is arranged in front of the first reflecting surface and the second reflecting surface, it is possible to prevent the electrical connection portion from being visually recognized from the front. As a result, it is possible to suppress an increase in the size of the lighting device including a plurality of light sources while avoiding a decrease in the product value.

The lighting device can be configured as follows.

The lighting device includes

a first connector electrically connected to the first light source; and

a second connector electrically connected to the second light source,

in which the first conducting wire is connected to the first connector from the front,

in which the second conducting wire is connected to the second connector from the front, and

in which the opaque cover covers the first connector and the second connector at least from the front.

According to such a configuration, it is possible to improve the efficiency of the connection work of the first conducting wire and the second conducting wire performed in assembling the lighting device. On the other hand, the first connector and the second connector are covered by the opaque cover at least from the front. Therefore, even when the first connector and the second connector are arranged in front of the first reflecting surface and the second reflecting surface, it is possible to prevent the first connector and the second connector from being visually recognized from the front. As a result, it is possible to improve the assembling workability of the lighting device including a plurality of light sources while avoiding a decrease in the product value.

The lighting device can be configured as follows.

The first reflecting surface, the second reflecting surface, and the opaque cover are parts of a single reflector member.

According to such a configuration, the reflector member can have a function of covering and concealing the electrical connection portion with the light source. In this way, the number of parts is reduced, and an increase in the size of the lighting device including a plurality of light sources can be suppressed.

### BRIEF DESCRIPTION OF DRAWINGS

FIG. 1 is a perspective view showing a headlamp according to a first embodiment;

FIG. 2 is a front view showing a part of the headlamp in FIG. 1;

FIG. 3 is a perspective view showing a part of the headlamp in FIG. 1;

FIG. 4 is a perspective view showing a part of the headlamp in FIG. 1;

FIG. 5 is a perspective view showing a part of the headlamp in FIG. 1;

FIG. 6 is a perspective view showing a part of the headlamp in FIG. 1;

FIG. 7 is a perspective view showing a heat dissipation member in the headlamp in FIG. 1;

FIG. 8 is a perspective view showing the heat dissipation member in the headlamp in FIG. 1;

FIG. 9 is a sectional view showing a part of the headlamp in FIG. 1;

FIG. 10 is a perspective view showing a part of the headlamp in FIG. 1;

FIG. 11 is a perspective view showing a headlamp according to a second embodiment;

FIG. 12 is a front view showing a part of the headlamp in FIG. 11;

FIG. 13 is a perspective view showing a part of the headlamp in FIG. 11;

FIG. 14 is a perspective view showing a part of the headlamp in FIG. 11;

FIG. 15 is a perspective view showing a part of the headlamp in FIG. 11;

FIG. 16 is a perspective view showing a part of the headlamp in FIG. 11;

FIG. 17 is a perspective view showing a heat dissipation member in the headlamp in FIG. 11;

FIG. 18 is a perspective view showing the heat dissipation member in the headlamp in FIG. 11;

FIG. 19 is a sectional view showing a part of the headlamp in FIG. 11;

FIG. 20 is a perspective view showing a part of the headlamp in FIG. 11; and

FIG. 21 is a perspective view showing an adjustment mechanism which can be provided in the headlamp in FIG. 11.

### DETAILED DESCRIPTION

Hereinafter, examples of embodiments will be described in detail with reference to the accompanying drawings. In each of the drawings used in the following description, the scale of each member is suitably changed in order to have a recognizable size. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In the accompanying drawings, the arrow F indicates the front direction of the structure shown. The arrow B indicates the rear direction of the structure shown. The arrow U indicates the upper direction of the structure shown. The arrow D indicates the lower direction of the structure shown. The arrow R indicates the right direction of the structure shown. The arrow L indicates the left direction of the structure shown. The “right” and “left” used in the following description indicate the left and right directions as viewed from a driver's seat.

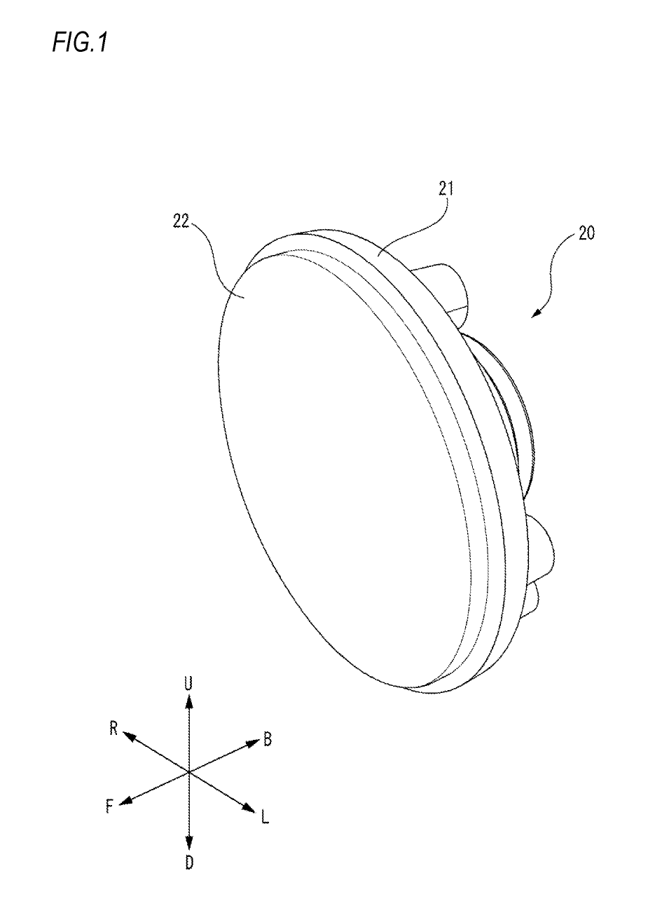

FIG. 1 shows an appearance of a headlamp 20 (an example of the lighting device) according to a first embodiment as viewed from the front left upper. The headlamp 20 is mounted on a front portion of a vehicle. The headlamp 20 includes a housing 21 and a translucent cover 22.

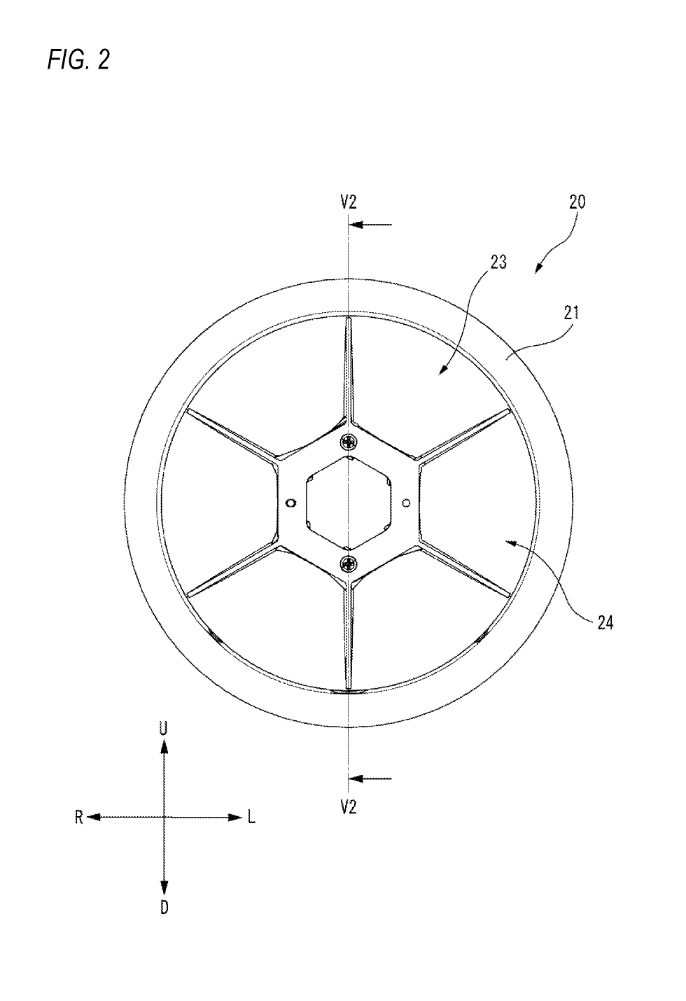

FIG. 2 is a front view showing an appearance of the headlamp 20 from which the translucent cover 22 is removed from the state shown in FIG. 1. The translucent cover 22 is mounted to the housing 21 and defines a lamp chamber 23. The headlamp 20 includes a reflector member 24. The reflector member 24 is accommodated in the lamp chamber 23.

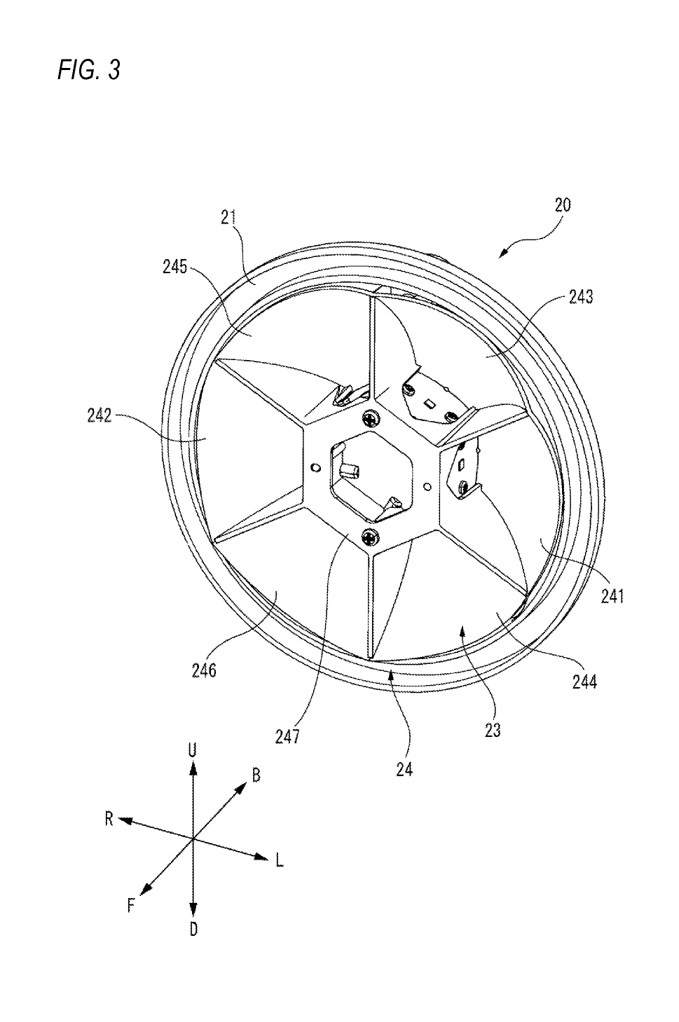

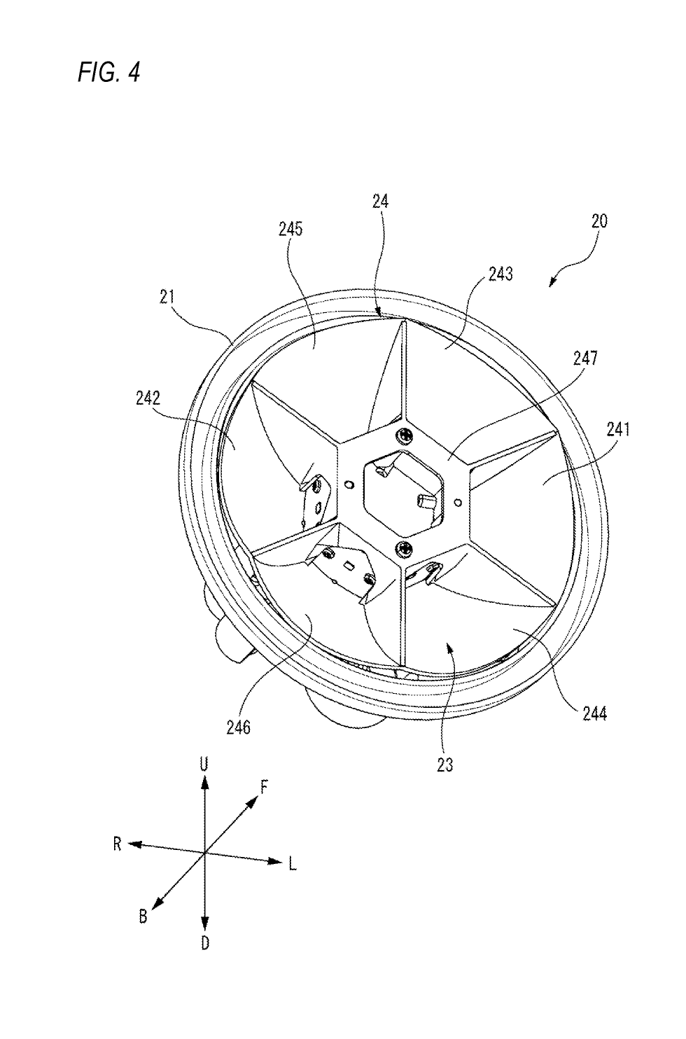

FIG. 3 shows an appearance of the headlamp 20 in the state shown in FIG. 2, as viewed from the front left upper. FIG. 4 shows an appearance of the headlamp 20 in the state shown in FIG. 2, as viewed from the front right lower.

The reflector member 24 is an integrally molded product made of resin or the like. The reflector member 24 has a left reflecting surface 241 (an example of the first reflecting surface), a right reflecting surface 242 (an example of the second reflecting surface), an upper left reflecting surface 243, a lower left reflecting surface 244, an upper right reflecting surface 245, a lower right reflecting surface 246, and an opaque cover portion 247.

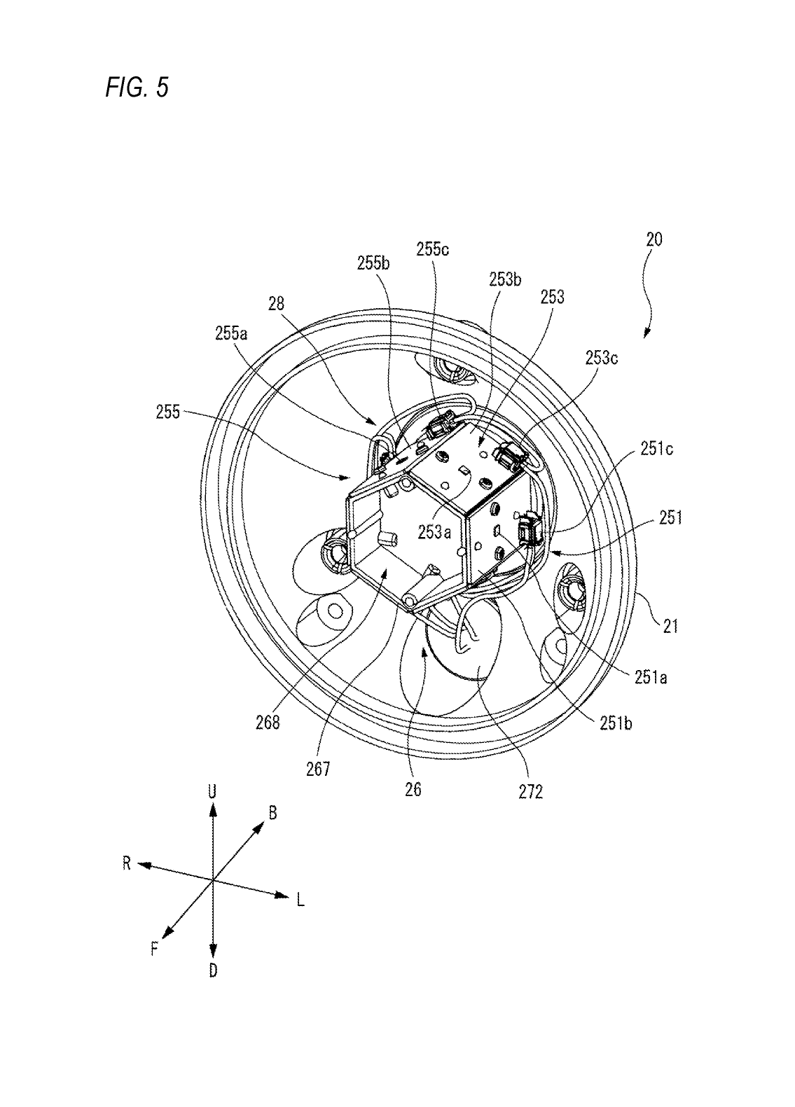

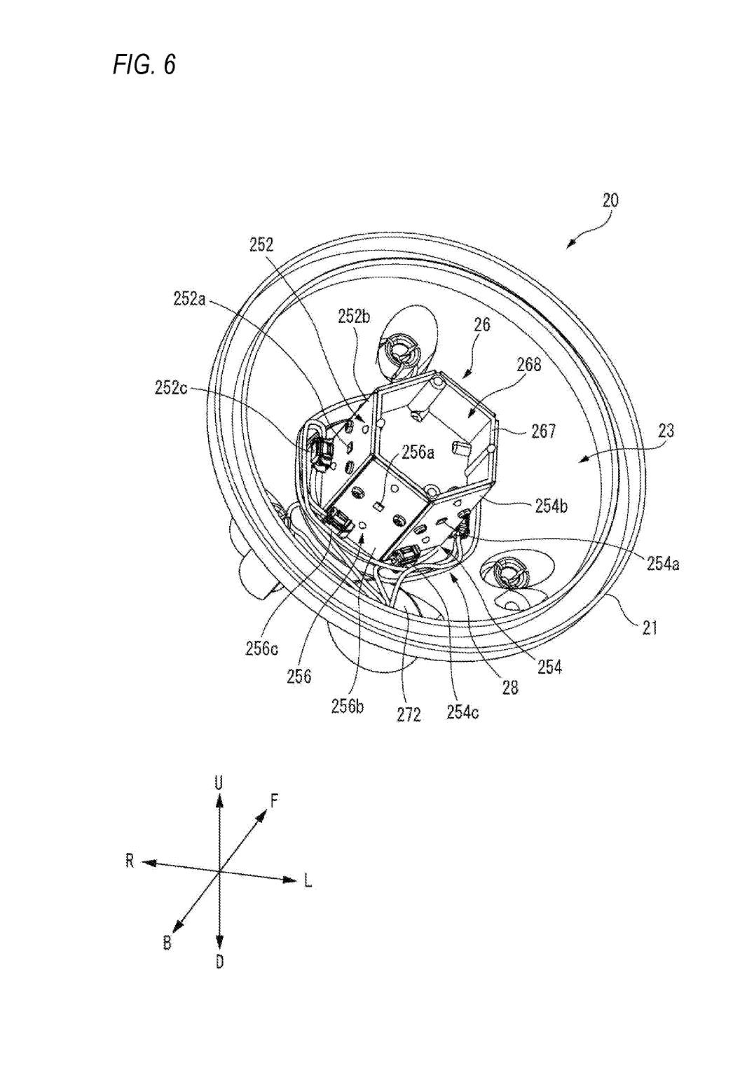

FIG. 5 shows an appearance of the headlamp 20 from which the reflector member 24 is removed from the state shown in FIG. 3, as viewed from the front left upper. FIG. 6 shows an appearance of the headlamp 20 from which the reflector member 24 is removed from the state shown in FIG. 4, as viewed from the front right lower.

The headlamp 20 includes a left light source unit 251, a right light source unit 252, an upper left light source unit 253, a lower left light source unit 254, an upper right light source unit 255, and a lower right light source unit 256.

The left light source unit 251 includes a left light source 251a (an example of the first light source), a left circuit board 251b, and a left connector 251c. The left circuit board 251b supports the left light source 251a and the left connector 251c. The left circuit board 251b has a circuit for electrically connecting the left light source 251a and the left connector 251c.

The right light source unit 252 includes a right light source 252a (an example of the second light source), a right circuit board 252b, and a right connector 252c. The right circuit board 252b supports the right light source 252a and the right connector 252c. The right circuit board 252b has a circuit for electrically connecting the right light source 252a and the right connector 252c.

The upper left light source unit 253 includes an upper left light source 253a, an upper left circuit board 253b, and an upper left connector 253c. The upper left circuit board 253b supports the upper left light source 253a and the upper left connector 253c. The upper left circuit board 253b has a circuit for electrically connecting the upper left light source 253a and the upper left connector 253c.

The lower left light source unit 254 includes a lower left light source 254a, a lower left circuit board 254b, and a lower left connector 254c. The lower left circuit board 254b supports the lower left light source 254a and the lower left connector 254c. The lower left circuit board 254b has a circuit for electrically connecting the lower left light source 254a and the lower left connector 254c.

The upper right light source unit 255 includes an upper right light source 255a, an upper right circuit board 255b, and an upper right connector 255c. The upper right circuit board 255b supports the upper right light source 255a and the upper right connector 255c. The upper right circuit board 255b has a circuit for electrically connecting the upper right light source 255a and the upper right connector 255c.

The lower right light source unit 256 includes a lower right light source 256a, a lower right circuit board 256b, and a lower right connector 256c. The lower right circuit board 256b supports the lower right light source 256a and the lower right connector 256c. The lower right circuit board 256b has a circuit for electrically connecting the lower right light source 256a and the lower right connector 256c.

The left light source 251a, the right light source 252a, the upper left light source 253a, the lower left light source 254a, the upper right light source 255a, and the lower right light source 256a are semiconductor light emitting elements for emitting light having a predetermined wavelength. Examples of the semiconductor light emitting element can include a light emitting diode (LED), a laser diode (LD), an organic EL element, or the like.

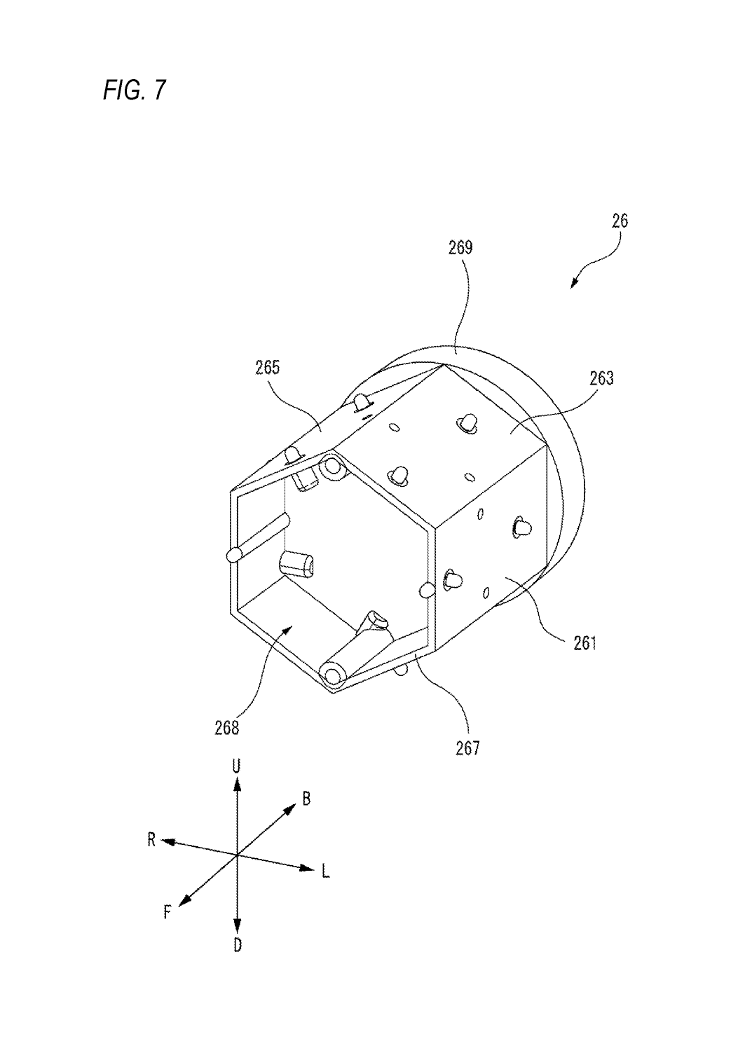

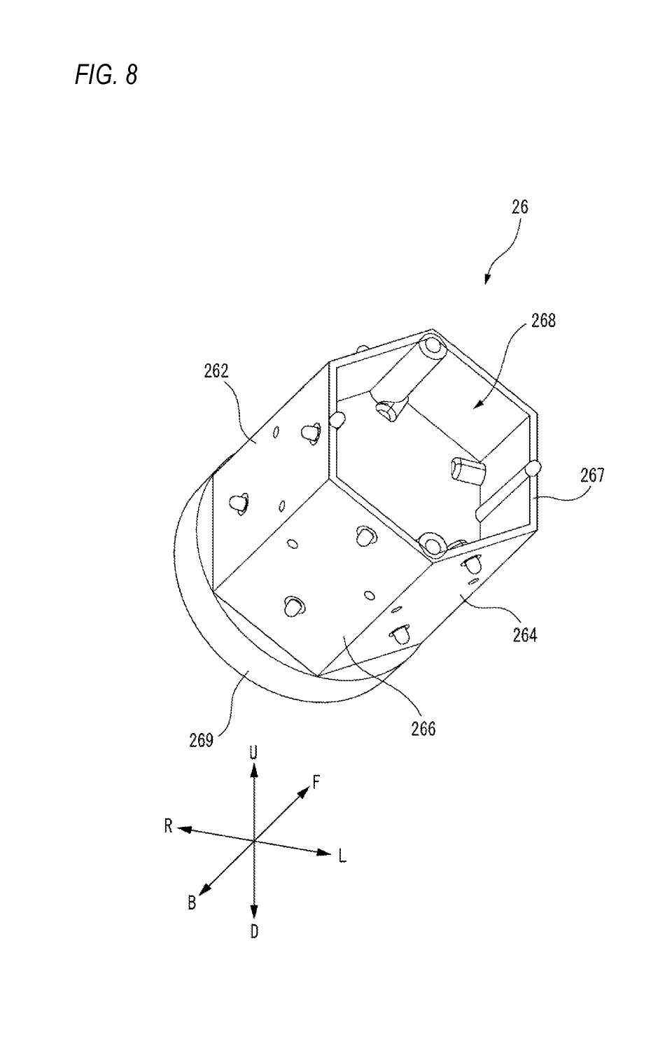

The headlamp 20 includes a heat dissipation member 26. The heat dissipation member 26 is formed of a material having a relatively high thermal conductivity, such as metal. FIG. 7 shows an appearance of the heat dissipation member 26 as viewed from the front left upper. FIG. 8 shows an appearance of the heat dissipation member 26 as viewed from the front right lower.

The heat dissipation member 26 has a left support surface 261, a right support surface 262, an upper left support surface 263, a lower left support surface 264, an upper right support surface 265, and a lower right support surface 266.

The left support surface 261 is a flat surface facing the left. The upper left support surface 263 is a flat surface facing the left upper. The upper left support surface 263 is positioned on the right side and on the upper side of the left support surface 261. The lower left support surface 264 is a flat surface facing the left lower. The lower left support surface 264 is positioned on the right side and on the lower side of the left support surface 261.

The right support surface 262 is a flat surface facing the right. The upper right support surface 265 is a flat surface facing the right upper. The upper right support surface 265 is positioned on the left side and on the upper side of the right support surface 262. The lower right support surface 266 is a flat surface facing the right lower. The lower right support surface 266 is positioned on the left side and on the lower side of the right support surface 262.

The heat dissipation member 26 has a wall portion 267. The wall portion 267 defines a bottomed hollow portion 268. The hollow portion 268 is opened to the front. The left support surface 261, the right support surface 262, the upper left support surface 263, the upper right support surface 265, the lower left support surface 264, and the lower right support surface 266 are parts of the wall portion 267.

As is apparent from FIGS. 5 and 7, the left support surface 261 supports the left circuit board 251b. The upper left support surface 263 supports the upper left circuit board 253b. The upper right support surface 265 supports the upper right circuit board 255b.

As is apparent from FIGS. 6 and 8, the right support surface 262 supports the right circuit board 252b. The lower left support surface 264 supports the lower left circuit board 254b. The lower right support surface 266 supports the lower right circuit board 256b.

Therefore, the heat dissipation member 26 is configured so as to dissipate heat generated by the operations of the left light source 251a, the right light source 252a, the upper left light source 253a, the lower left light source 254a, the upper right light source 255a, and the lower right light source 256a.

The left light source 251a, the right light source 252a, the upper left light source 253a, the lower left light source 254a, the upper right light source 255a, and the lower right light source 256a are disposed at positions facing the hollow portion 268 with the wall portion 267 of the heat dissipation member 26 interposed therebetween.

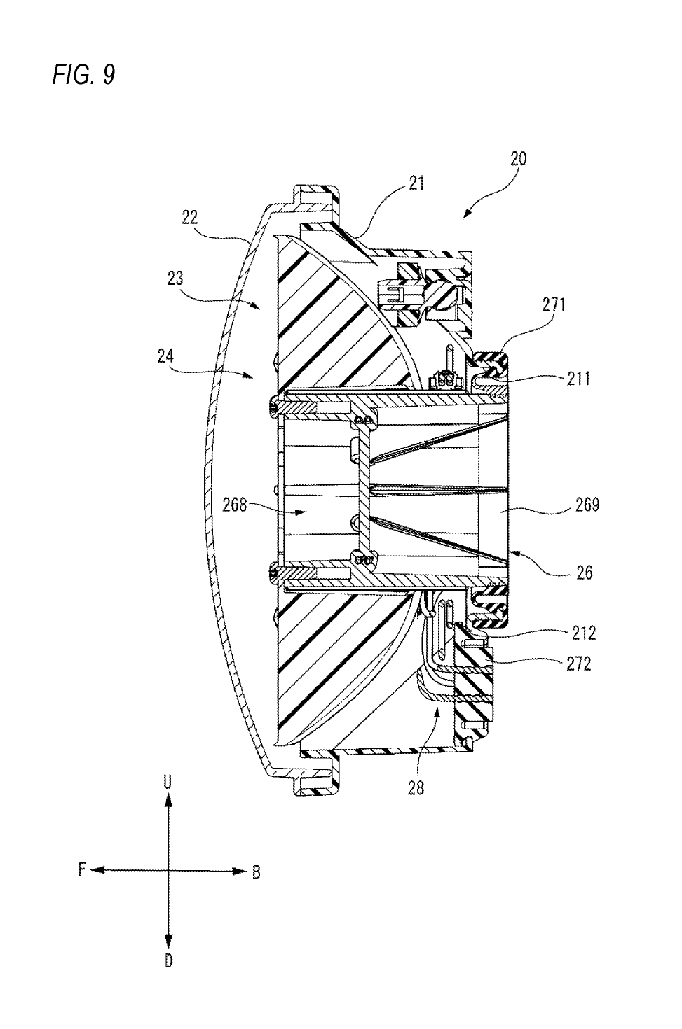

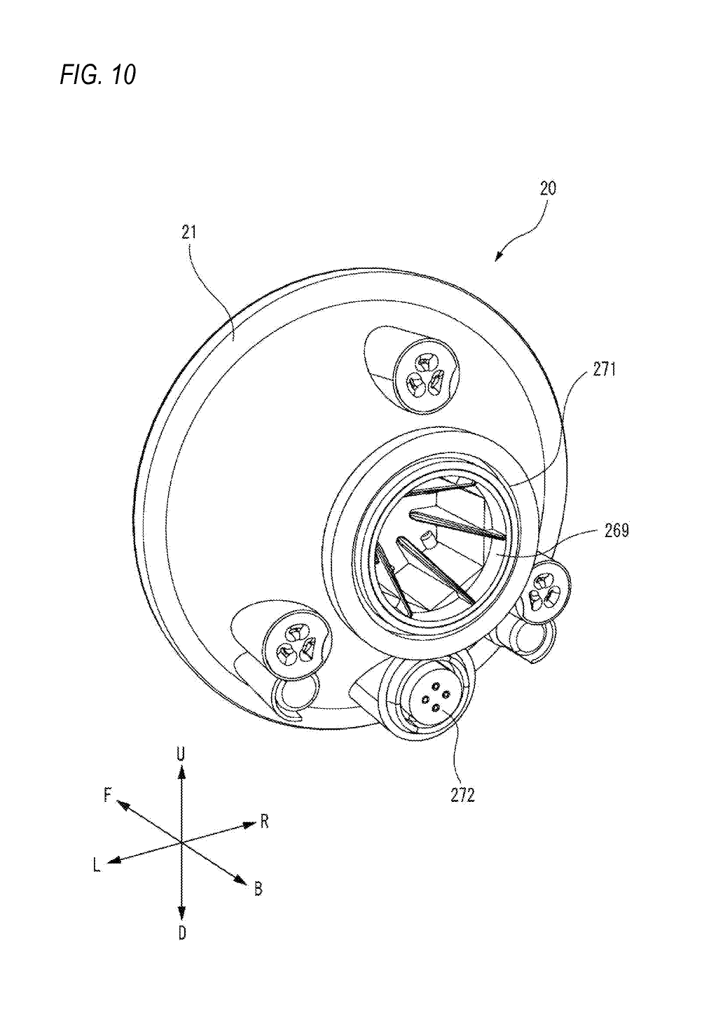

FIG. 9 is a sectional view taken along the line V2-V2 in FIG. 2, showing a configuration of the headlamp 20 as viewed from the direction of the arrow. Here, the translucent cover 22 is also shown. FIG. 10 shows an appearance of the headlamp 20 as viewed from the rear left upper.

Most of the heat dissipation member 26 is accommodated in the lamp chamber 23. A rear end portion 269 of the heat dissipation member 26 is exposed to the outside of the headlamp 20 through a first opening 211 formed in a rear portion of the housing 21.

The headlamp 20 includes a first sealing member 271. The first sealing member 271 is formed of an elastically deformable material. The first sealing member 271 seals a gap between the first opening 211 of the housing 21 and the rear end portion 269 of the heat dissipation member 26. The example of the first sealing member 271 can include an O ring or a gasket.

The headlamp 20 includes a second sealing member 272. The second sealing member 272 is formed of an elastically deformable material. The second sealing member 272 is fitted into a second opening 212 formed in a rear portion of the housing 21. The second opening 212 is sealed by the second sealing member 272.

The headlamp 20 includes a plurality of conducting wires 28. The plurality of conducting wires 28 are drawn to the outside of the headlamp 20 through a plurality of through-holes formed in the second sealing member 272. The plurality of conducting wires 28 are electrically connected to a control unit (not shown) on the vehicle side.

As shown in FIGS. 5 and 6, the plurality of conducting wires 28 are connected to the left connector 251c of the left light source unit 251, the right connector 252c of the right light source unit 252, the upper left connector 253c of the upper left light source unit 253, the lower left connector 254c of the lower left light source unit 254, the upper right connector 255c of the upper right light source unit 255, and the lower right connector 256c of the lower right light source unit 256, respectively.

Specifically, the plurality of conducting wires 28 include a conducting wire (an example of the first conducting wire) electrically connected to the left light source 251a, a conducting wire (an example of the second conducting wire) electrically connected to the right light source 252a, a conducting wire electrically connected to the upper left light source 253a, a conducting wire electrically connected to the lower left light source 254a, a conducting wire electrically connected to the upper right light source 255a, and a conducting wire electrically connected to the lower right light source 256a.

As shown in FIG. 9, the reflector member 24 is mounted to the heat dissipation member 26.

As is apparent from FIGS. 3 and 5, the opaque cover portion 247 of the reflector member 24 covers at least a front end of the left circuit board 251b, at least a front end of the upper left circuit board 253b, and at least a front end of the upper right circuit board 255b.

The left reflecting surface 241, the upper left reflecting surface 243, and the upper right reflecting surface 245 of the reflector member 24 cover the left connector 251c, the upper left connector 253c, and the upper right connector 255c at least from the front, respectively. Further, the left reflecting surface 241, the upper left reflecting surface 243, and the upper right reflecting surface 245 of the reflector member 24 cover the plurality of conducting wires 28 connected to the left connector 251c, the upper left connector 253c, and the upper right connector 255c at least from the front.

As is apparent from FIGS. 4 and 6, the opaque cover portion 247 of the reflector member 24 covers at least a front end of the right circuit board 252b, at least a front end of the lower left circuit board 254b, and at least a front end of the lower right circuit board 256b.

The right reflecting surface 242, the lower left reflecting surface 244, and the lower right reflecting surface 246 of the reflector member 24 cover the right connector 252c, the lower left connector 254c, and the lower right connector 256c at least from the front, respectively. Further, the right reflecting surface 242, the lower left reflecting surface 244, and the lower right reflecting surface 246 of the reflector member 24 cover the plurality of conducting wires 28 connected to the right connector 252c, the lower left connector 254c, and the lower right connector 256c at least from the front.

Electric energy (which is at least one of voltage and current and whose value may change over time) supplied from the control unit on the vehicle side is supplied to the left light source 251a, the right light source 252a, the upper left light source 253a, the lower left light source 254a, the upper right light source 255a, and the lower right light source 256a through the plurality of conducting wires 28, respectively.

As is apparent from FIGS. 3 and 5, when electric energy is supplied to the left light source 251a, the left light source 251a emits light toward the left (an example of a direction intersecting with the front and rear direction). The light emitted from the left light source 251a is reflected toward the front (an example of a predetermined direction) by the left reflecting surface 241 of the reflector member 24. The reflected light passes through the translucent cover 22 and illuminates the front of the headlamp 20.

Similarly, when electric energy is supplied to the upper left light source 253a (an example of the third light source), the upper left light source 253a emits light toward the left upper (an example of a direction intersecting with the front and rear direction). The light emitted from the upper left light source 253a is reflected toward the front by the upper left reflecting surface 243 of the reflector member 24. The reflected light passes through the translucent cover 22 and illuminates the front of the headlamp 20.

Similarly, when electric energy is supplied to the upper right light source 255a (an example of the third light source), the upper right light source 255a emits light toward the right upper (an example of a direction intersecting with the front and rear direction). The light emitted from the upper right light source 255a is reflected toward the front by the upper right reflecting surface 245 of the reflector member 24. The reflected light passes through the translucent cover 22 and illuminates the front of the headlamp 20.

As is apparent from FIGS. 4 and 6, when electric energy is supplied to the right light source 252a, the right light source 252a emits light toward the right (an example of a direction intersecting with the front and rear direction). The light emitted from the right light source 252a is reflected toward the front (an example of a predetermined direction) by the right reflecting surface 242 of the reflector member 24. The reflected light passes through the translucent cover 22 and illuminates the front of the headlamp 20.

Similarly, when electric energy is supplied to the lower left light source 254a (an example of the third light source), the lower left light source 254a emits light toward the left lower (an example of a direction intersecting with the front and rear direction). The light emitted from the lower left light source 254a is reflected toward the front by the lower left reflecting surface 244 of the reflector member 24. The reflected light passes through the translucent cover 22 and illuminates the front of the headlamp 20.

Similarly, when electric energy is supplied to the lower right light source 256a (an example of the third light source), the lower right light source 256a emits light toward the right lower (an example of a direction intersecting with the front and rear direction). The light emitted from the lower right light source 256a is reflected toward the front upper by the lower right reflecting surface 246 of the reflector member 24. The reflected light passes through the translucent cover 22 and illuminates the front of the headlamp 20.

As described above, the headlamp 20 according to the present embodiment includes the reflector member 24, the left light source 251a, the right light source 252a, and the heat dissipation member 26. The heat dissipation member 26 has the wall portion 267 defining the hollow portion 268. The heat dissipation member 26 dissipates heat generated by the operations of the left light source 251a and the right light source 252a. The reflector member 24 is mounted to the heat dissipation member 26. The left light source 251a and the right light source 252a are disposed at positions facing the hollow portion 268 with the wall portion 267 interposed therebetween, respectively. Each of the left light source 251a and the right light source 252a emits light in a direction intersecting with the front and rear direction of the headlamp 20. The reflector member 24 is an integrally molded product and has the left reflecting surface 241 and the right reflecting surface 242. The left reflecting surface 241 reflects light emitted from the left light source 251a in a predetermined direction. The right reflecting surface 242 reflects light emitted from the right light source 252a in a predetermined direction.

According to the above configuration, the light emitted from the left light source 251a is reflected by the left reflecting surface 241 of the reflector member 24, and the light emitted from the right light source 252a is reflected by the right reflecting surface 242 of the reflector member 24. Since the space spreading in a direction intersecting with the front and rear direction of the headlamp 20 having a relatively high degree of freedom of layout can be effectively utilized, it is easy to suppress an increase in the size in the front and rear direction, as compared to the configuration as disclosed in Patent Document in which the distribution of the light emitted forward from the light source is controlled by a lens part formed in the translucent cover.

Further, since the left light source 251a and the right light source 252a are disposed at positions facing the hollow portion 268 of the heat dissipation member 26 having a large surface area, the heat generated by the operations of the left light source 251a and the right light source 252a can be effectively dissipated. Therefore, the volume of the heat dissipation member 26 necessary for obtaining desired heat dissipation performance can be reduced, and an increase in the size of the headlamp 20 can be suppressed.

Furthermore, since the left reflecting surface 241 and the right reflecting surface 242 are parts of a single reflector member 24, the number of steps for mounting to the heat dissipation member 26 can be minimized.

In the present embodiment, the headlamp 20 includes the plurality of conducting wires 28 electrically connected to the left light source 251a and the right light source 252a. The plurality of conducting wires 28 are arranged behind the reflector member 24.

According to this configuration, the reflector member 24 mounted to the heat dissipation member 26 can have a function of covering and concealing the plurality of conducting wires 28. In this way, the number of parts is reduced, and an increase in the size of the headlamp 20 can be suppressed.

The above description can be similarly applied to other light sources provided in the headlamp 20.

In the present embodiment, the left light source 251a, the right light source 252a, the upper left light source 253a, the lower left light source 254a, the upper right light source 255a, and the lower right light source 256a emit light in directions intersecting with the front and rear direction of the headlamp 20.

According to such a configuration, three or more light sources can be arranged with high space utilization efficiency. In this way, an increase in the size of the headlamp 20 can be suppressed.

The above embodiment is merely an example for facilitating the understanding of the disclosure. The configuration according to the above embodiment can be appropriately modified and improved without departing from the gist of the disclosure.

In the first embodiment, the single reflector member 24 mounted to the heat dissipation member 26 has the left reflecting surface 241, the right reflecting surface 242, the upper left reflecting surface 243, the lower left reflecting surface 244, the upper right reflecting surface 245, and the lower right reflecting surface 246. However, the reflector member 24 may be formed by integrating a plurality of subunits, and each subunit may have a plurality of reflecting surfaces which reflect light emitted from a plurality of light sources disposed at positions facing the hollow portion 268 with the wall portion 267 of the heat dissipation member 26 interposed therebetween.

In the first embodiment, the plurality of conducting wires 28 are electrically connected to the left light source 251a, the right light source 252a, the upper left light source 253a, the lower left light source 254a, the upper right light source 255a, and the lower right light source 256a via the left connector 251c, the right connector 252c, the upper left connector 253c, the lower left connector 254c, the upper right connector 255c, and the lower right connector 256c, respectively. However, the plurality of conducting wires 28 may be electrically connected to the respective light sources by soldering or the like to the contacts without connectors.

In the first embodiment, the left reflecting surface 241, the right reflecting surface 242, the upper left reflecting surface 243, the lower left reflecting surface 244, the upper right reflecting surface 245, and the lower right reflecting surface 246 of the reflector member 24 are configured so that all of the left light source 251a, the right light source 252a, the upper left light source 253a, the lower left light source 254a, the upper right light source 255a, and the lower right light source 256a illuminate the front. However, the area illuminated by each light source can be appropriately determined according to the specifications of the headlamp. For example, the left reflecting surface 241 and the right reflecting surface 242 of the reflector member 24 may be configured so that the left light source 251a and the right light source 252a illuminate different areas in front of the headlamp 20.

In the first embodiment, the headlamp 20 is exemplified as an example of the lighting device. However, the disclosure may be applied to various lighting devices which are configured to be mounted on a vehicle and include a plurality of light sources and a heat dissipation member. The front and rear direction, the left and right direction, and the upper and lower direction of the headlamp 20 are coincident with the front and rear direction, the left and right direction, and the upper and lower direction of the vehicle, respectively. However, depending on the lighting device to which the disclosure is applied, at least one of the front and rear direction, the left and right direction, and the upper and lower direction of the lighting device is not coincident with the front and rear direction, the left and right direction, and the upper and lower direction of the vehicle.

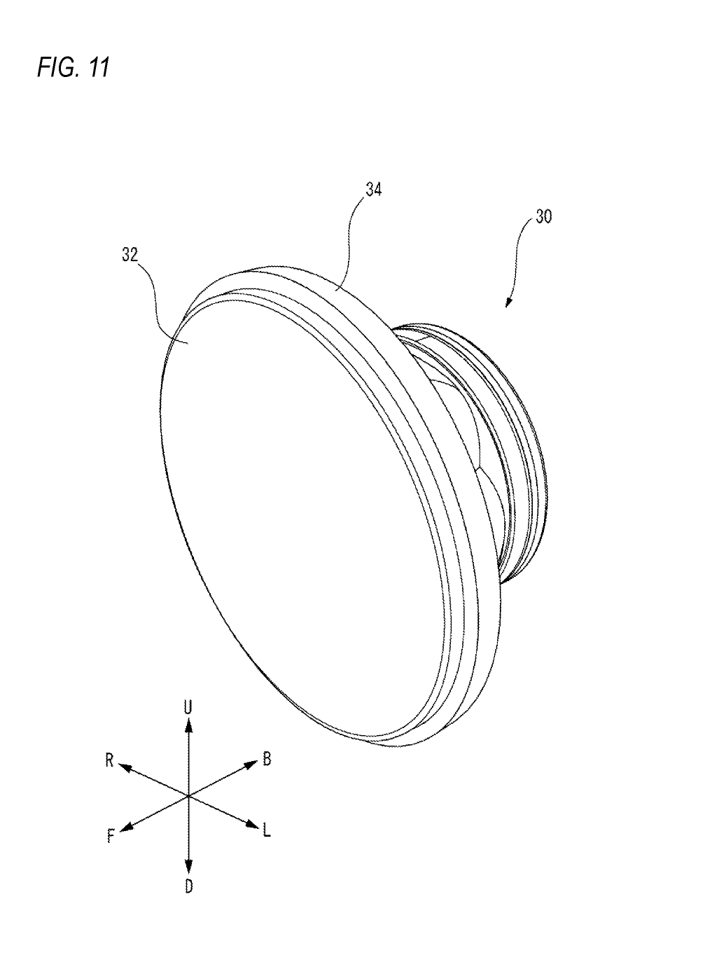

FIG. 11 shows an appearance of a headlamp 30 (an example of the lighting device) according to a second embodiment as viewed from the front left upper. The headlamp 30 is mounted on a front portion of a vehicle. The headlamp 30 includes a translucent cover 32 and a reflector member 34.

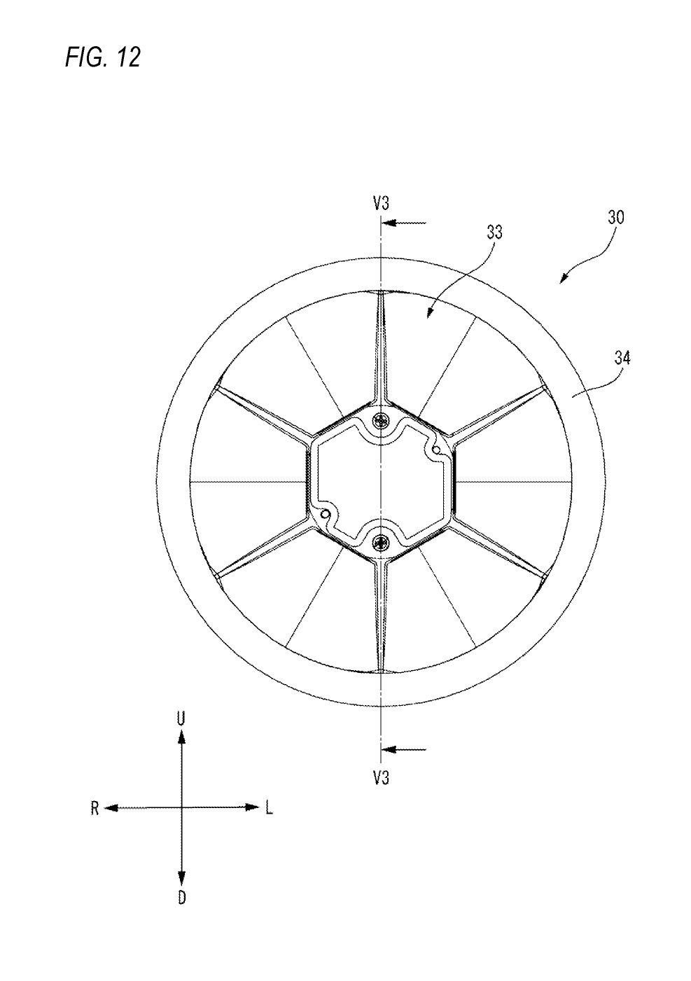

FIG. 12 is a front view showing an appearance of the headlamp 30 from which the translucent cover 32 is removed from the state shown in FIG. 11. The translucent cover 32 is mounted to the reflector member 34 and defines a lamp chamber 33.

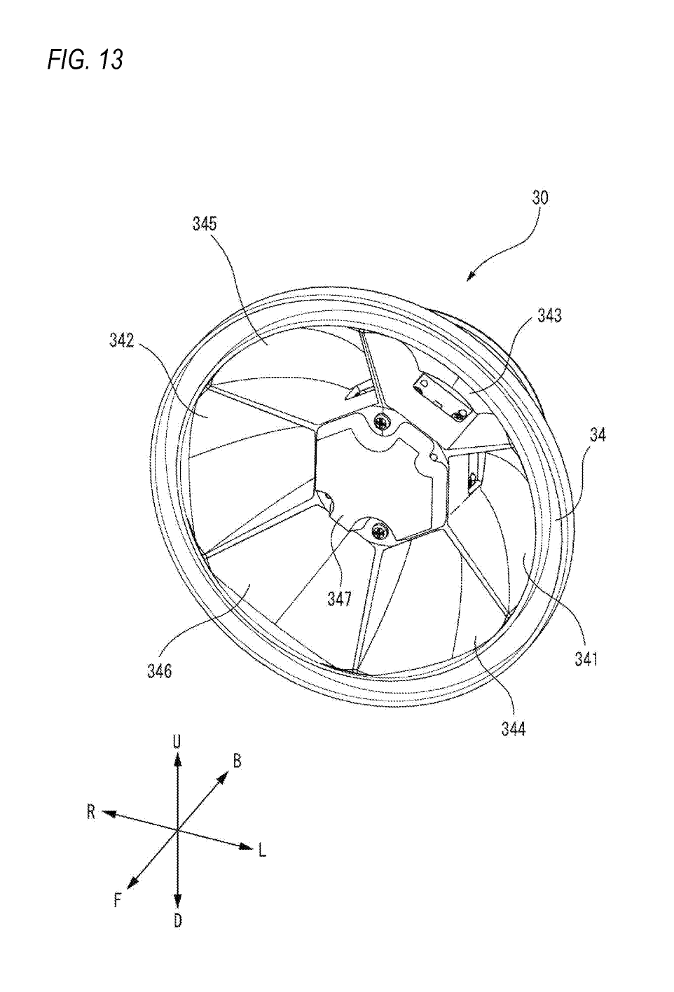

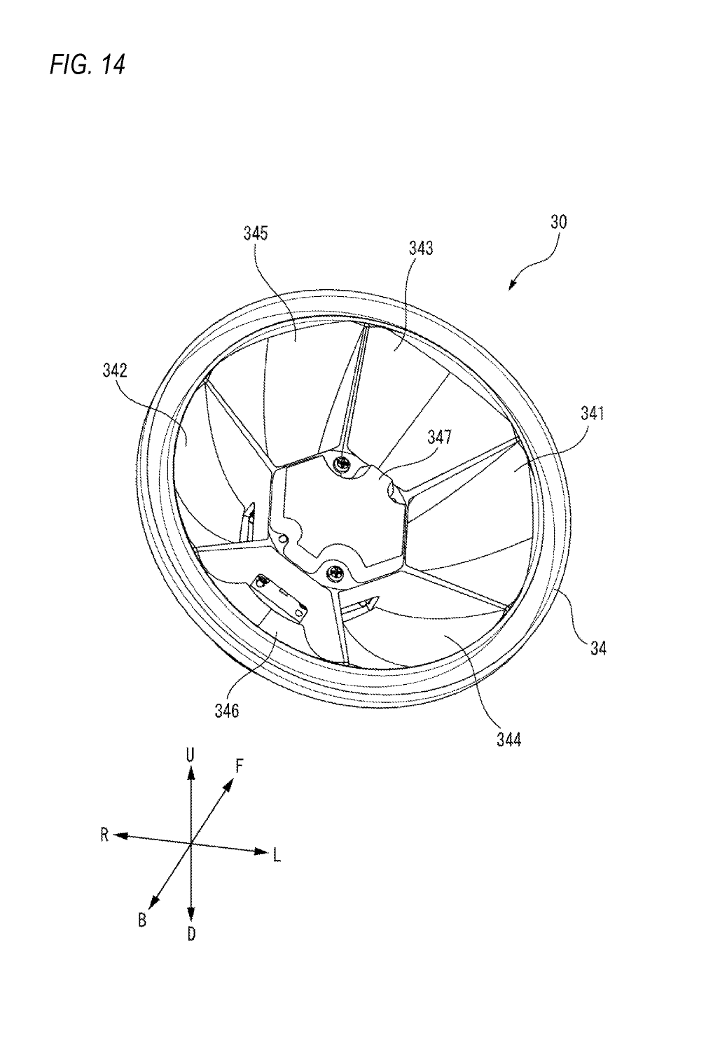

FIG. 13 shows an appearance of the headlamp 30 in the state shown in FIG. 12, as viewed from the front left upper. FIG. 14 shows an appearance of the headlamp 30 in the state shown in FIG. 12, as viewed from the front right lower.

The reflector member 34 is an integrally molded product made of resin or the like. The reflector member 34 has a left reflecting surface 341 (an example of the first reflecting surface), a right reflecting surface 342 (an example of the second reflecting surface), an upper left reflecting surface 343, a lower left reflecting surface 344, an upper right reflecting surface 345, a lower right reflecting surface 346, and an opaque cover portion 347.

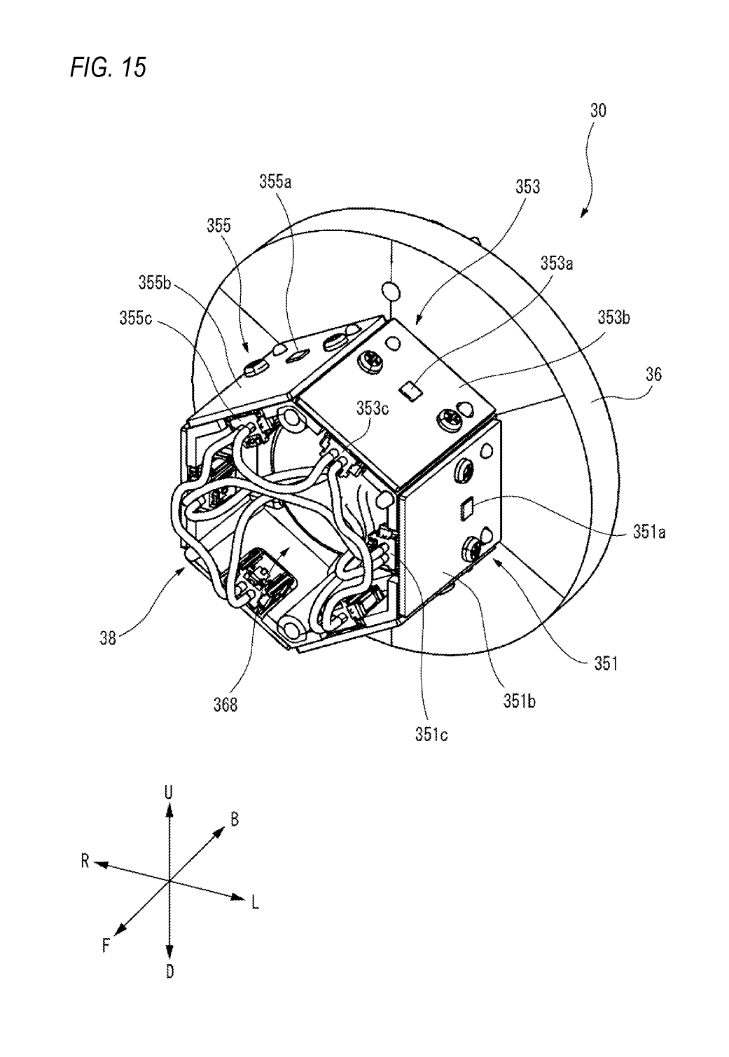

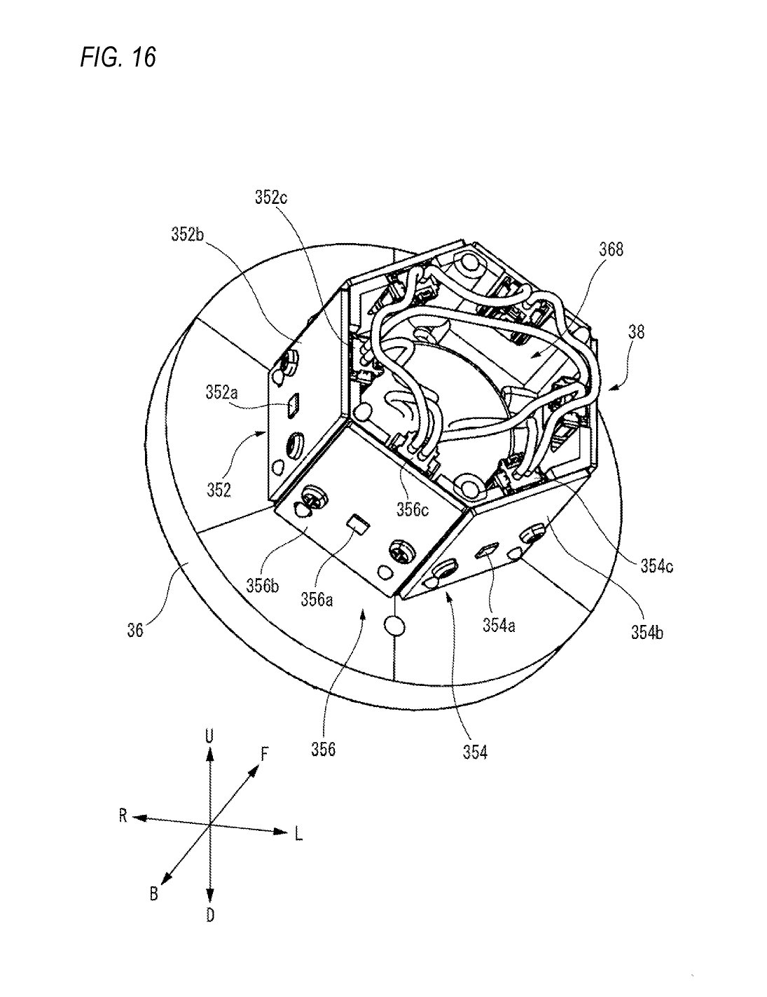

FIG. 15 shows an appearance of the headlamp 30 from which the reflector member 34 is removed from the state shown in FIG. 13, as viewed from the front left upper. FIG. 16 shows an appearance of the headlamp 30 from which the reflector member 34 is removed from the state shown in FIG. 14, as viewed from the front right lower.

The headlamp 30 includes a left light source unit 351, a right light source unit 352, an upper left light source unit 353, a lower left light source unit 354, an upper right light source unit 355, and a lower right light source unit 356.

The left light source unit 351 includes a left light source 351a (an example of the first light source), a left circuit board 351b, and a left connector 351c. The left circuit board 351b supports the left light source 351a and the left connector 351c. The left circuit board 351b has a circuit for electrically connecting the left light source 351a and the left connector 351c.

The right light source unit 352 includes a right light source 352a (an example of the second light source), a right circuit board 352b, a right connector 352c. The right circuit board 352b supports the right light source 352a and the right connector 352c. The right circuit board 352b has a circuit for electrically connecting the right light source 352a and the right connector 352c.

The upper left light source unit 353 includes an upper left light source 353a, an upper left circuit board 353b, and an upper left connector 353c. The upper left circuit board 353b supports the upper left light source 353a and the upper left connector 353c. The upper left circuit board 353b has a circuit for electrically connecting the upper left light source 353a and the upper left connector 353c.

The lower left light source unit 354 includes a lower left light source 354a, a lower left circuit board 354b, and a lower left connector 354c. The lower left circuit board 354b supports the lower left light source 354a and the lower left connector 354c. The lower left circuit board 354b has a circuit for electrically connecting the lower left light source 354a and the lower left connector 354c.

The upper right light source unit 355 includes an upper right light source 355a, an upper right circuit board 355b, and an upper right connector 355c. The upper right circuit board 355b supports the upper right light source 355a and the upper right connector 355c. The upper right circuit board 355b has a circuit for electrically connecting the upper right light source 355a and the upper right connector 355c.

The lower right light source unit 356 includes a lower right light source 356a, a lower right circuit board 356b, and a lower right connector 356c. The lower right circuit board 356b supports the lower right light source 356a and the lower right connector 356c. The lower right circuit board 356b has a circuit for electrically connecting the lower right light source 356a and the lower right connector 356c.

The left light source 351a, the right light source 352a, the upper left light source 353a, the lower left light source 354a, the upper right light source 355a, and the lower right light source 356a are semiconductor light emitting elements for emitting light having a predetermined wavelength. Examples of the semiconductor light emitting element can include a light emitting diode (LED), a laser diode (LD), an organic EL element, or the like.

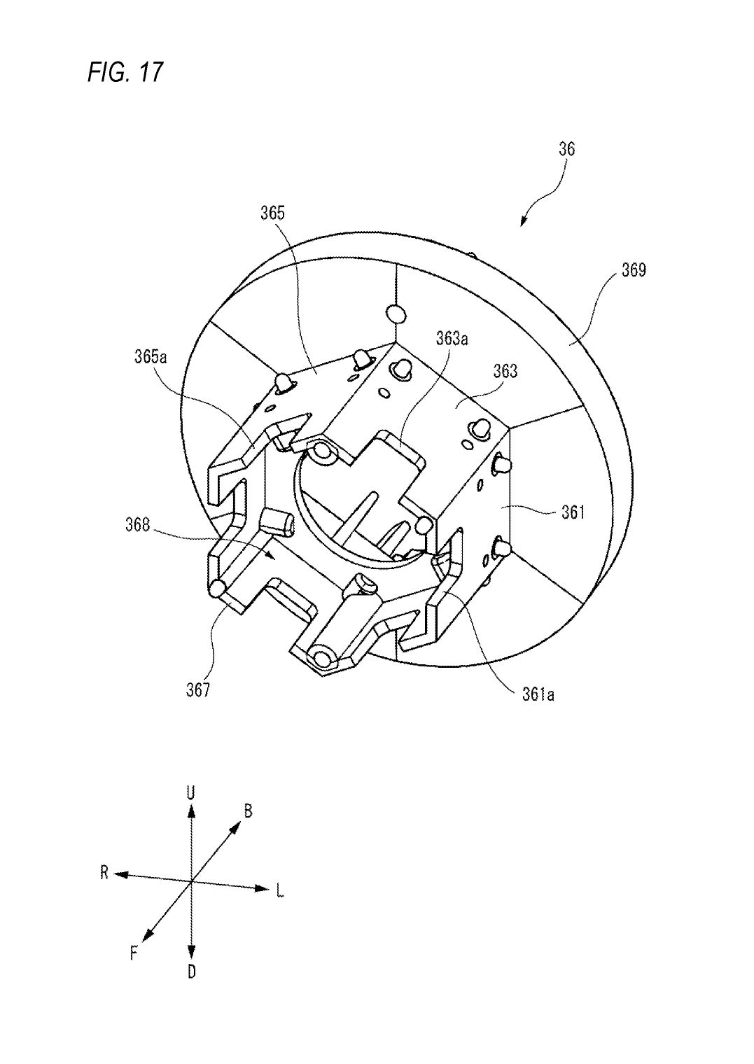

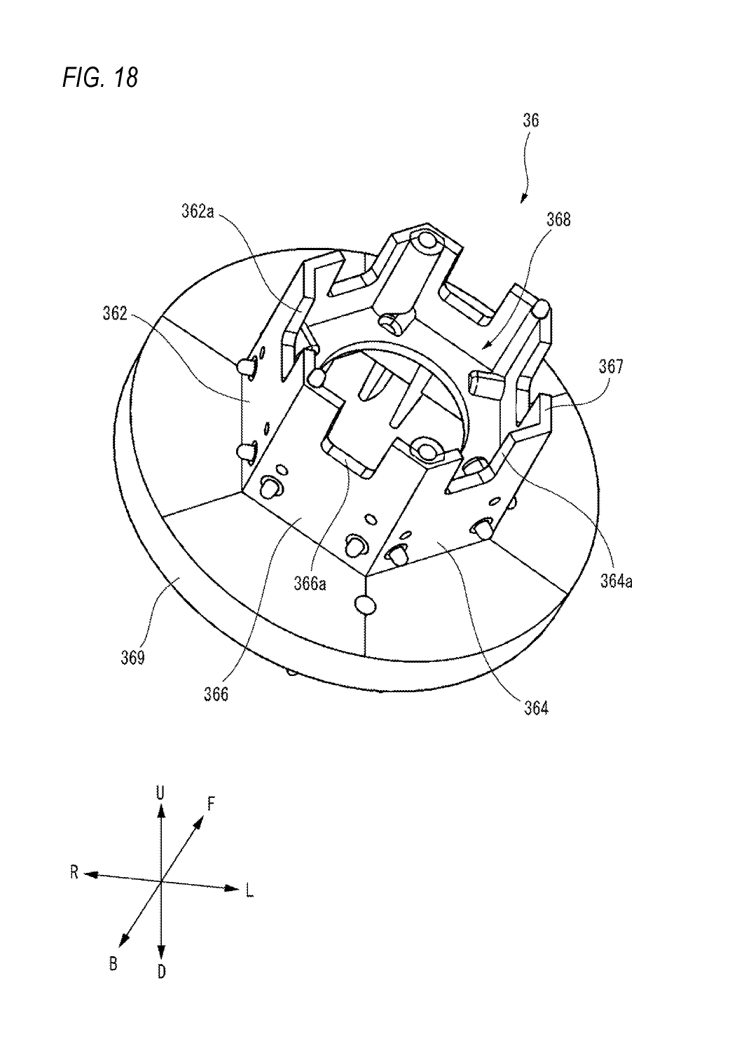

The headlamp 30 includes a heat dissipation member 36. The heat dissipation member 36 is formed of a material having a relatively high thermal conductivity, such as metal. FIG. 17 shows an appearance of the heat dissipation member 36 as viewed from the front left upper. FIG. 18 shows an appearance of the heat dissipation member 36 as viewed from the front right lower.

The heat dissipation member 36 has a left support surface 361, a right support surface 362, an upper left support surface 363, a lower left support surface 364, an upper right support surface 365, and a lower right support surface 366.

The left support surface 361 is a flat surface facing the left. The upper left support surface 363 is a flat surface facing the left upper. The upper left support surface 363 is positioned on the right side and on the upper side of the left support surface 361. The lower left support surface 364 is a flat surface facing the left lower. The lower left support surface 364 is positioned on the right side and on the lower side of the left support surface 361.

The right support surface 362 is a flat surface facing the right. The upper right support surface 365 is a flat surface facing the right upper. The upper right support surface 365 is positioned on the left side and on the upper side of the right support surface 362. The lower right support surface 366 is a flat surface facing the right lower. The lower right support surface 366 is positioned on the left side and on the lower side of the right support surface 362.

The heat dissipation member 36 has a wall portion 367. The wall portion 367 defines a hollow portion 368 which is a through-hole opened in the front and rear direction. The left support surface 361, the right support surface 362, the upper left support surface 363, the upper right support surface 365, the lower left support surface 364, and the lower right support surface 366 are parts of the wall portion 367.

As is apparent from FIGS. 15 and 17, the left support surface 361 supports the left circuit board 351b. The upper left support surface 363 supports the upper left circuit board 353b. The upper right support surface 365 supports the upper right circuit board 355b.

As is apparent from FIGS. 16 and 18, the right support surface 362 supports the right circuit board 352b. The lower left support surface 364 supports the lower left circuit board 354b. The lower right support surface 366 supports the lower right circuit board 356b.

Therefore, the heat dissipation member 36 is configured so as to dissipate heat generated by the operations of the left light source 351a, the right light source 352a, the upper left light source 353a, the lower left light source 354a, the upper right light source 355a, and the lower right light source 356a.

The left light source 351a, the right light source 352a, the upper left light source 353a, the lower left light source 354a, the upper right light source 355a, and the lower right light source 356a are disposed at positions facing the hollow portion 368 with the wall portion 367 of the heat dissipation member 36 interposed therebetween.

A part of the wall portion 367 forming the left support surface 361 has a left recessed portion 361a. The left recessed portion 361a is opened to the front. When the left circuit board 351b is mounted to the left support surface 361, the left connector 351c is accommodated in the left recessed portion 361a. The left connector 351c is disposed in the hollow portion 368.

A part of the wall portion 367 forming the right support surface 362 has a right recessed portion 362a. The right recessed portion 362a is opened to the front. When the right circuit board 352b is mounted to the right support surface 362, the right connector 352c is accommodated in the right recessed portion 362a. The right connector 352c is disposed in the hollow portion 368.

Apart of the wall portion 367 forming the upper left support surface 363 has an upper left recessed portion 363a. The upper left recessed portion 363a is opened to the front. When the upper left circuit board 353b is mounted to the upper left support surface 363, the upper left connector 353c is accommodated in the upper left recessed portion 363a. The upper left connector 353c is disposed in the hollow portion 368.

A part of the wall portion 367 forming the lower left support surface 364 has a lower left recessed portion 364a. The lower left recessed portion 364a is opened to the front. When the lower left circuit board 354b is mounted to the lower left support surface 364, the lower left connector 354c is accommodated in the lower left recessed portion 364a. The lower left connector 354c is disposed in the hollow portion 368.

A part of the wall portion 367 forming the upper right support surface 365 has an upper right recessed portion 365a. The upper right recessed portion 365a is opened to the front. When the upper right circuit board 355b is mounted to the upper right support surface 365, the upper right connector 355c is accommodated in the upper right recessed portion 365a. The upper right connector 355c is disposed in the hollow portion 368.

A part of the wall portion 367 forming the lower right support surface 366 has a lower right recessed portion 366a. The lower right recessed portion 366a is opened to the front. When the lower right circuit board 356b is mounted to the lower right support surface 366, the lower right connector 356c is accommodated in the lower right recessed portion 366a. The lower right connector 356c is disposed in the hollow portion 368.

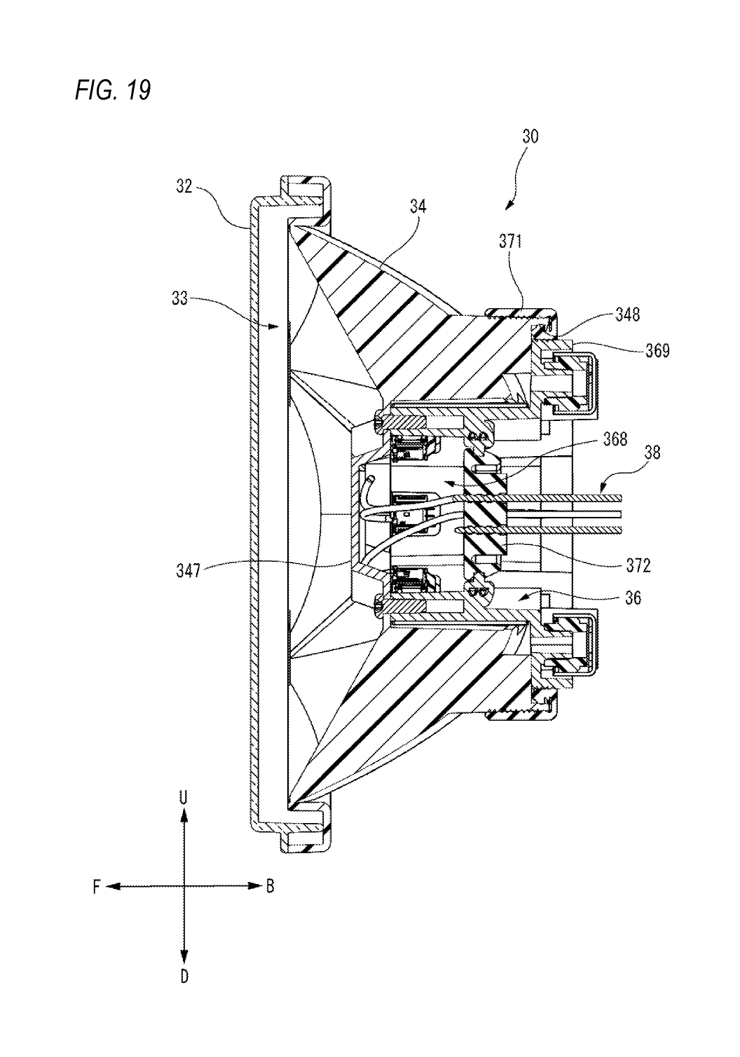

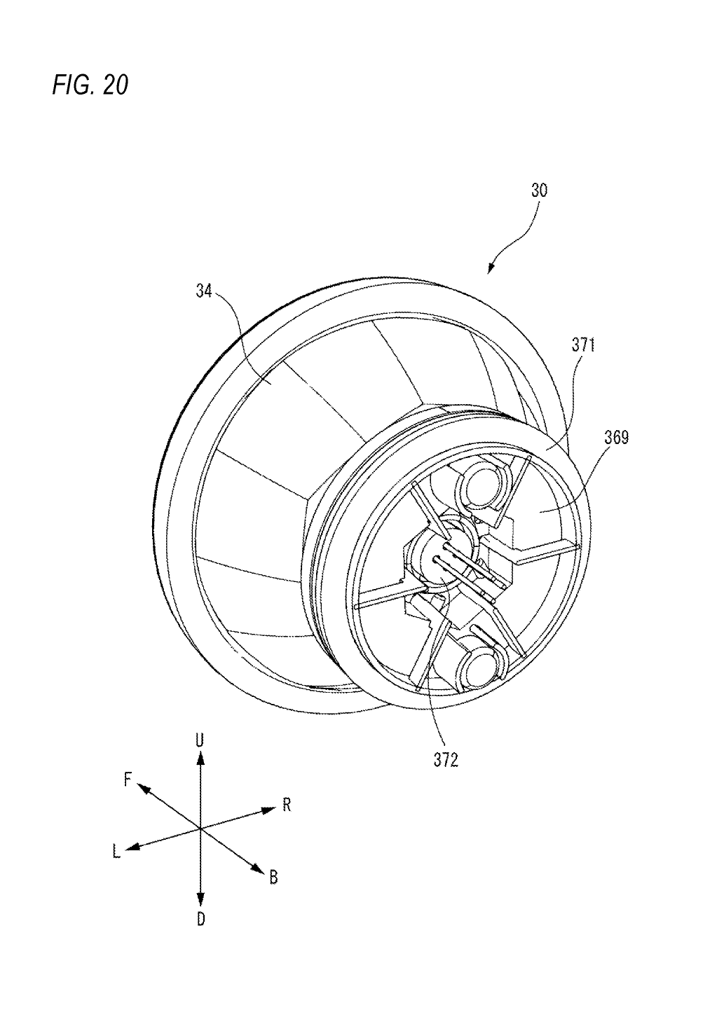

FIG. 19 is a sectional view taken along the line V3-V3 in FIG. 12, showing a configuration of the headlamp 30 as viewed from the direction of the arrow. Here, the translucent cover 32 is also shown. FIG. 20 shows an appearance of the headlamp 30 as viewed from the rear left upper.

Most of the heat dissipation member 36 is accommodated in the lamp chamber 33. A rear end portion 369 of the heat dissipation member 36 is exposed to the outside of the headlamp 30 through an opening 348 formed in a rear portion of the reflector member 34.

The headlamp 30 includes a first sealing member 371. The first sealing member 371 is formed of an elastically deformable material. The first sealing member 371 seals a gap between the opening 348 of the reflector member 34 and the rear end portion 369 of the heat dissipation member 36. The example of the first sealing member 371 can include an O ring or a gasket.

The headlamp 20 includes a second sealing member 372. The second sealing member 372 is formed of an elastically deformable material. The second sealing member 372 is fitted into a rear portion of the hollow portion 368 of the heat dissipation member 36. The rear portion of the hollow portion 368 is sealed by the second sealing member 372.

The headlamp 30 includes a plurality of conducting wires 38. The plurality of conducting wires 38 are drawn to the outside of the headlamp 30 through a plurality of through-holes formed in the second sealing member 372. The plurality of conducting wires 38 are electrically connected to a control unit (not shown) on the vehicle side.

As shown in FIGS. 15 and 16, the plurality of conducting wires 38 extends in the hollow portion 368 of the heat dissipation member 36. The plurality of conducting wires 38 are electrically connected, from the front, to the left connector 351c of the left light source unit 351, the right connector 352c of the right light source unit 352, the upper left connector 353c of the upper left light source unit 353, the lower left connector 354c of the lower left light source unit 354, the upper right connector 355c of the upper right light source unit 355, and the lower right connector 356c of the lower right light source unit 356, respectively.

Specifically, the plurality of conducting wires 38 include a conducting wire (an example of the first conducting wire) electrically connected to the left light source 351a, a conducting wire (an example of the second conducting wire) electrically connected to the right light source 352a, a conducting wire electrically connected to the upper left light source 353a, a conducting wire electrically connected to the lower left light source 354a, a conducting wire electrically connected to the upper right light source 355a, and a conducting wire electrically connected to the lower right light source 356a.

As shown in FIG. 19, the reflector member 34 is mounted to the heat dissipation member 36.

As is apparent from FIGS. 13 and 15, the left connector 351c, the upper left connector 353c, and the upper right connector 355c are arranged in front of the left reflecting surface 341, the upper left reflecting surface 343, and the upper right reflecting surface 345 of the reflector member 34, respectively.

The opaque cover portion 347 of the reflector member 34 covers at least a front end of the left circuit board 351b, at least a front end of the upper left circuit board 353b, and at least a front end of the upper right circuit board 355b. Further, the opaque cover portion 347 covers the left connector 351c, the upper left connector 353c, the upper right connector 355c, and the plurality of conducting wires 38 connected to these connectors at least from the front.

As is apparent from FIGS. 14 and 16, the right connector 352c, the lower left connector 354c, and the lower right connector 356c are arranged in front of the right reflecting surface 342, the lower left reflecting surface 344, and the lower right reflecting surface 346 of the reflector member 34, respectively.

The opaque cover portion 347 of the reflector member 34 covers at least a front end of the right circuit board 352b, at least a front end of the lower left circuit board 354b, and at least a front end of the lower right circuit board 356b. Further, the opaque cover portion 347 covers the right connector 352c, the lower left connector 354c, the lower right connector 356c, and the plurality of conducting wires 38 connected to these connectors at least from the front.

Electric energy (which is at least one of voltage and current and whose value may change over time) supplied from the control unit on the vehicle side is supplied to the left light source 351a, the right light source 352a, the upper left light source 353a, the lower left light source 354a, the upper right light source 355a, and the lower right light source 356a through the plurality of conducting wires 38, respectively.

As is apparent from FIGS. 13 and 15, when electric energy is supplied to the left light source 351a, the left light source 351a emits light toward the left (an example of a direction intersecting with the front and rear direction). The light emitted from the left light source 351a is reflected toward the front (an example of a predetermined direction) by the left reflecting surface 341 of the reflector member 34. The reflected light passes through the translucent cover 32 and illuminates the front of the headlamp 30.

Similarly, when electric energy is supplied to the upper left light source 353a (an example of the third light source), the upper left light source 353a emits light toward the left upper (an example of a direction intersecting with the front and rear direction). The light emitted from the upper left light source 353a is reflected toward the front by the upper left reflecting surface 343 of the reflector member 34. The reflected light passes through the translucent cover 32 and illuminates the front of the headlamp 30.

Similarly, when electric energy is supplied to the upper right light source 355a (an example of the third light source), the upper right light source 355a emits light toward the right upper (an example of a direction intersecting with the front and rear direction). The light emitted from the upper right light source 355a is reflected toward the front by the upper right reflecting surface 345 of the reflector member 34. The reflected light passes through the translucent cover 32 and illuminates the front of the headlamp 30.

As is apparent from FIGS. 14 and 16, when electric energy is supplied to the right light source 352a, the right light source 352a emits light toward the right (an example of a direction intersecting with the front and rear direction). The light emitted from the right light source 352a is reflected toward the front (an example of a predetermined direction) by the right reflecting surface 342 of the reflector member 34. The reflected light passes through the translucent cover 32 and illuminates the front of the headlamp 30.

Similarly, when electric energy is supplied to the lower left light source 354a (an example of the third light source), the lower left light source 354a emits light toward the left lower (an example of a direction intersecting with the front and rear direction). The light emitted from the lower left light source 354a is reflected toward the front by the lower left reflecting surface 344 of the reflector member 34. The reflected light passes through the translucent cover 32 and illuminates the front of the headlamp 30.

Similarly, when electric energy is supplied to the lower right light source 356a (an example of the third light source), the lower right light source 356a emits light toward the right lower (an example of a direction intersecting with the front and rear direction). The light emitted from the lower right light source 356a is reflected toward the front upper by the lower right reflecting surface 346 of the reflector member 34. The reflected light passes through the translucent cover 32 and illuminates the front of the headlamp 30.

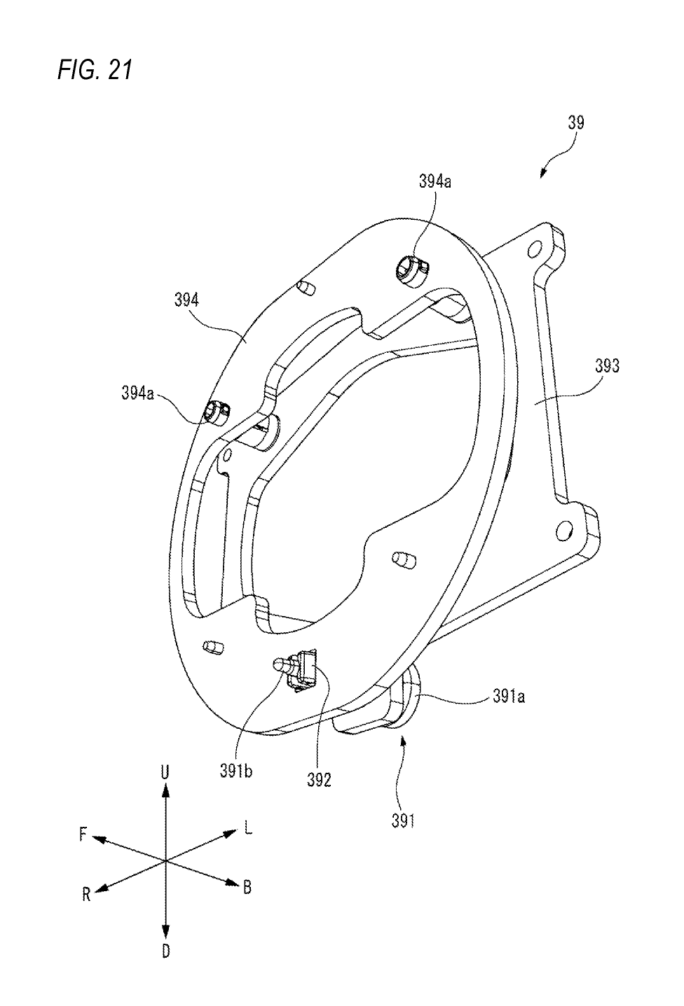

Due to errors in assembling a product or variations in mounting accuracy to vehicles, an error from a prescribed specification may occur on the posture of the reflector member 14 in some cases. In order to avoid a situation where a desired light distribution pattern cannot be obtained due to the error, the headlamp 30 can include an adjustment mechanism 39 shown in FIG. 21. The adjustment mechanism 39 includes a screw 391, a joint 392, a support plate 393, and a posture control plate 394.

The screw 391 has a screw head 391a and a screw shaft 391b. The screw 391 extends through a lower portion of the support plate 393. The screw head 391a can be rotatably operated by a predetermined tool. A screw groove is formed on an outer peripheral surface of the screw shaft 391b.

The joint 392 is provided in a lower portion of the posture control plate 394. The joint 392 has a through-hole. A screw groove (not shown) is formed on an inner peripheral surface of the through-hole. The screw shaft 391b extends in the through-hole of the joint 392. The screw groove formed on the outer peripheral surface of the screw shaft 391b is screwed into the screw groove formed in the through-hole of the joint 392.

The support plate 393 is fixed to a predetermined position in a vehicle. The posture control plate 394 is fixed to a rear portion of the reflector member 34. An upper portion of the posture control plate 394 is connected to the support plate 393 via a pair of connecting portions 394a. The pair of connecting portions 394a is configured by a universal joint or the like and can be displaced at least in the upper and lower direction.

When the screw head 391a is rotationally operated by a predetermined tool, the screw shaft 391b is rotated in the operation direction. The rotation of the screw shaft 391b is converted into the movement in the front and rear direction of the joint 392 via the screw grooves. In this way, the reflector member 34 can be tilted forward or backward from its original posture, so that it is possible to eliminate the errors from the prescribed specifications. Such adjustment of the posture of the reflector member 34 is performed before shipment of the headlamp 30 or during maintenance.

As described above, the headlamp 30 according to the present embodiment includes the reflector member 34, the left light source 351a, the right light source 352a, and the heat dissipation member 36. The heat dissipation member 36 has the wall portion 367 defining the hollow portion 368. The heat dissipation member 36 dissipates heat generated by the operations of the left light source 351a and the right light source 352a. The reflector member 34 is mounted to the heat dissipation member 36. The left light source 351a and the right light source 352a are disposed at positions facing the hollow portion 368 with the wall portion 367 interposed therebetween, respectively. The left light source 351a and the right light source 352a emit light in directions intersecting with the front and rear direction of the headlamp 30, respectively. The reflector member 34 is an integrally molded product, and has the left reflecting surface 341 and the right reflecting surface 342. The left reflecting surface 341 reflects light emitted from the left light source 351a in a predetermined direction. The right reflecting surface 342 reflects light emitted from the right light source 352a in a predetermined direction.

According to the above configuration, the light emitted from the left light source 351a is reflected by the left reflecting surface 341 of the reflector member 34, and the light emitted from the right light source 352a is reflected by the right reflecting surface 342 of the reflector member 34. Since the space spreading in a direction intersecting with the front and rear direction of the headlamp 30 having a relatively high degree of freedom of layout can be effectively utilized, it is easy to suppress an increase in the size in the front and rear direction, as compared to the configuration as disclosed in Patent Document in which the distribution of the light emitted forward from the light source is controlled by a lens part formed in the translucent cover.

Further, since the left light source 351a and the right light source 352a are disposed at positions facing the hollow portion 368 of the heat dissipation member 36 having a large surface area, the heat generated by the operations of the left light source 351a and the right light source 352a can be effectively dissipated. Therefore, the volume of the heat dissipation member 36 necessary for obtaining desired heat dissipation performance can be reduced, and an increase in the size of the headlamp 30 can be suppressed.

Furthermore, since the left reflecting surface 341 and the right reflecting surface 342 are parts of a single reflector member 34, the number of steps for mounting to the heat dissipation member 36 can be minimized.

In the present embodiment, the headlamp 30 includes the plurality of conducting wires 38 electrically connected to the left light source 351a and the right light source 352a. The plurality of conducting wires 38 extend in the hollow portion 368 of the heat dissipation member 36.

That is, the hollow portion 368 formed for improving the heat dissipation property is utilized as a space for arranging the plurality of conducting wires 38. In this way, the utilization efficiency of the space is improved and an increase in the size of the headlamp 30 can be suppressed.

The above description can be similarly applied to other light sources provided in the headlamp 30.

In the present embodiment, the translucent cover 32 is mounted to the reflector member 34.

According to such a configuration, the reflector member 34 can function as a housing defining the lamp chamber 33. A mechanism for adjusting the posture of the reflector member 34 may be provided outside the reflector member 34, as necessary. Therefore, it is possible to further suppress an increase in the size of the headlamp 30. Further, a watertight structure can be formed by the translucent cover 32, the reflector member 34, the first sealing member 371, and the second sealing member 372.

In the present embodiment, the left light source 351a, the right light source 352a, the upper left light source 353a, the lower left light source 354a, the upper right light source 355a, and the lower right light source 356a emit light in directions intersecting with the front and rear direction of the headlamp 30.

According to such a configuration, three or more light sources can be arranged with high space utilization efficiency. In this way, an increase in the size of the headlamp 30 can be suppressed.

The above embodiment is merely an example for facilitating the understanding of the disclosure. The configuration according to the above embodiment can be appropriately modified and improved without departing from the gist of the disclosure.

In the second embodiment, the single reflector member 34 mounted to the heat dissipation member 36 has the left reflecting surface 341, the right reflecting surface 342, the upper left reflecting surface 343, the lower left reflecting surface 344, the upper right reflecting surface 345, and the lower right reflecting surface 346. However, the reflector member 34 may be formed by integrating a plurality of subunits, and each subunit may have a plurality of reflecting surfaces which reflect light emitted from a plurality of light sources disposed at positions facing the hollow portion 368 with the wall portion 367 of the heat dissipation member 36 interposed therebetween.

In the second embodiment, the plurality of conducting wires 38 are electrically connected to the left light source 351a, the right light source 352a, the upper left light source 353a, the lower left light source 354a, the upper right light source 355a, and the lower right light source 356a via the left connector 351c, the right connector 352c, the upper left connector 353c, the lower left connector 354c, the upper right connector 355c, and the lower right connector 356c, respectively. However, the plurality of conducting wires 38 may be electrically connected to the respective light sources by soldering or the like to the contacts without connectors.

In the second embodiment, the left reflecting surface 341, the right reflecting surface 342, the upper left reflecting surface 343, the lower left reflecting surface 344, the upper right reflecting surface 345, and the lower right reflecting surface 346 of the reflector member 34 are configured so that all of the left light source 351a, the right light source 352a, the upper left light source 353a, the lower left light source 354a, the upper right light source 355a, and the lower right light source 356a illuminate the front. However, the area illuminated by each light source can be appropriately determined according to the specifications of the headlamp. For example, the left reflecting surface 341 and the right reflecting surface 342 of the reflector member 34 may be configured so that the left light source 351a and the right light source 352a illuminate different areas in front of the headlamp 30.

In the second embodiment, the headlamp 30 is exemplified as an example of the lighting device. However, the disclosure may be applied to various lighting devices which are configured to be mounted on a vehicle and include a plurality of light sources and a heat dissipation member. The front and rear direction, the left and right direction, and the upper and lower direction of the headlamp 30 are coincident with the front and rear direction, the left and right direction, and the upper and lower direction of the vehicle, respectively. However, depending on the lighting device to which the disclosure is applied, at least one of the front and rear direction, the left and right direction, and the upper and lower direction of the lighting device is not coincident with the front and rear direction, the left and right direction, and the upper and lower direction of the vehicle.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A lighting device mounted on a vehicle, the lighting device comprising:
a first light source;
a second light source;
a heat dissipation member having a wall defining a hollow portion and configured to dissipate heat generated by operations of the first light source and the second light source; and
a single reflector member mounted on the heat dissipation member,
wherein the first light source and the second light source are disposed at positions facing the hollow portion with the wall interposed therebetween, respectively,
wherein the first light source and the second light source are configured to emit light in directions intersecting with a front and rear direction, respectively, and
wherein the reflector member has
a first reflecting surface configured to reflect light emitted from the first light source in a predetermined direction, and
a second reflecting surface configured to reflect light emitted from the second light source in a predetermined direction.

2. The lighting device according to claim 1, further comprising:
a first conducting wire electrically connected to the first light source; and
a second conducting wire electrically connected to the second light source,
wherein the first conducting wire and the second conducting wire are disposed behind the reflector member.

3. The lighting device according to claim 1, further comprising:
a first conducting wire electrically connected to the first light source; and
a second conducting wire electrically connected to the second light source,
wherein the first conducting wire and the second conducting wire extend in the hollow portion.

4. The lighting device according to claim 3, further comprising:
a translucent cover through which light emitted from the first light source and the second light source is transmitted,
wherein the translucent cover is mounted to the reflector member.

5. The lighting device according to claim 1, further comprising;
a third light source disposed at a position facing the hollow portion with the wall portion interposed therebetween,
wherein the third light source is configured to emit light in a direction intersecting with the front and rear direction.

6. The lighting device according to claim 1,
wherein the first light source is configured to emit light for illuminating a first area, and
wherein the second light source is configured to emit light for illuminating a second area different from the first area.

7. A lighting device mounted on a vehicle, the lighting device comprising:
a first light source;
a first reflecting surface configured to reflect light emitted from the first light source in a predetermined direction;
a first conducting wire electrically connected to the first light source in front of the first reflecting surface;
a second light source;
a second reflecting surface configured to reflect light emitted from the second light source in a predetermined direction;
a second conducting wire electrically connected to the second light source in front of the second reflecting surface; and
an opaque cover covering the first conducting wire and the second conducting wire at least from a front.

8. The lighting device according to claim 7, comprising;
a first connector electrically connected to the first light source; and
a second connector electrically connected to the second light source,
wherein the first conducting wire is connected to the first connector from the front,
wherein the second conducting wire is connected to the second connector from the front, and
wherein the opaque cover covers the first connector and the second connector at least from the front.

9. The lighting device according to claim 7,
wherein the first reflecting surface, the second reflecting surface, and the opaque cover are parts of a single reflector member.
